(19) United States
(12) Patent Application Publication
(10) Pub. No.: US 2010/0270947 A1
(43) Pub. Date: Oct. 28, 2010

(54) CURRENT-SHARING SUPPLY CIRCUIT FOR DRIVING MULTIPLE SETS OF DC LOADS

(75) Inventors: Shih-Hsien Chang, Taoyuan Hsien (TW); Po-Nien Ko, Taoyuan Hsien (TW)

Correspondence Address: KIRTON AND MCCONKIE, 60 EAST SOUTH TEMPLE,, SUITE 1800, SALT LAKE CITY, UT, 84111, US

(73) Assignee: DELTA ELECTRONICS, INC., Taoyuan Hsien (TW)

(21) Appl. No.: 12/752,234

(22) Filed: Apr. 1, 2010

(30) Foreign Application Priority Data
Apr. 27, 2009 (TW) 098113932

(51) Int. Cl. H05B 41/36

(52) U.S. Cl. 315/294

(57) ABSTRACT

A current-sharing supply circuit includes a current providing circuit, a current-sharing circuit, a first output rectifier circuit and a second output rectifier circuit. The current providing circuit receives an input voltage and generating a first current or a first voltage, thereby providing electrical energy to a first set of DC loads and a second set of DC loads. The first output rectifier circuit is interconnected between the first set of DC loads and a first output terminal of the current-sharing circuit, thereby generating a first output current to the first set of DC loads. The second output rectifier circuit is interconnected between the second set of DC loads and a second output terminal of the current-sharing circuit, thereby generating a second output current to the second set of DC loads. The first output current and the second output current are balanced by the current-sharing circuit.

### FIELD OF THE INVENTION

The present invention relates to a current-sharing supply circuit, and more particularly to a current-sharing supply circuit for driving multiple sets of DC loads.

### BACKGROUND OF THE INVENTION

In recent years, light emitting diodes (LEDs) capable of emitting light with high luminance and high illuminating efficiency have been developed. In comparison with a common incandescent light, a LED has lower power consumption, long service life, and quick response speed. With the maturity of the LED technology, LEDs will replace all conventional lighting facilities. Until now, LEDs are widely used in many aspects of daily lives, such as automobile lighting devices, handheld lighting devices, backlight sources for LCD panels, traffic lights, indicator board displays, and the like.

When an electronic device (e.g. a LCD panel) having multiple LED strings is operated, the currents passing through all LED strings shall be identical for a purpose of obtaining uniform brightness. Due to different inherent characteristics of these LED strings, the currents passing therethrough are not identical and the brightness is usually not uniform. Therefore, the use life of individual LED string is shortened or even the whole electronic device has a breakdown.

Generally, the LED can be considered as a DC load. When an electronic device (e.g. a LCD panel) having multiple LED strings is operated, the currents passing through all LED strings shall be identical for a purpose of obtaining uniform brightness. Due to different inherent characteristics of these LED strings, the currents passing these LED strings are not identical and the brightness is usually not uniform. Therefore, the use life of individual LED string is shortened or even the whole electronic device has a breakdown

For obtaining uniform brightness of multiple LED strings, several current-sharing techniques have been disclosed. For example, as shown in FIG. 1, U.S. Pat. No. 6,621,235 disclosed a current-sharing supply circuit for driving multiple LED strings. The current-sharing supply circuit of FIG. 1 principally includes a linear regulator 11, a low-pass filter 12 and multiple current mirrors M₁˜Mₙ. A constant reference current I_{ref} is inputted into a first terminal of the linear regulator 11. The linear regulator 11 is controlled with the constant reference current I_{ref} and thus an output voltage is generated and transmitted to the low-pass filter 12. The output voltage is filtered by the low-pass filter 12 and then transmitted to the gates of the current mirrors M₁˜Mₙ. As a consequence, these current mirrors M₁˜Mₙ outputs identical currents. In other words, the LED strings linked to the current mirrors M₁˜Mₙ have the same current and brightness.

The conventional current-sharing supply circuit for driving multiple LED strings, however, still has some drawbacks. For example, since the linear regulator and the current mirrors are employed, the conventional current-sharing supply circuit has high power loss but low operating efficiency. In addition, since more components are used, the conventional current-sharing supply circuit is very complicated.

There is a need of providing an improved current-sharing supply circuit for driving multiple sets of DC loads to obviate the drawbacks encountered from the prior art.

### SUMMARY OF THE INVENTION

It is an object of the present invention to provide a current-sharing supply circuit for driving multiple sets of DC loads, in which the currents passing through all sets of DC loads are identical.

Another object of the present invention provides a current sharing supply circuit for driving multiple sets of DC loads, in which the current sharing supply circuit has minimized power loss, high operating efficiency and simplified circuitry configuration.

A further object of the present invention provides a current sharing supply circuit for driving multiple sets of DC loads, in which the overall volume of the current-sharing supply circuit is reduced but the circuitry density is enhanced.

In accordance with a first aspect of the present invention, there is provided a current-sharing supply circuit for driving a first set of DC loads and a second set of DC loads. The current-sharing supply circuit includes a current providing circuit, a current-sharing circuit, a first output rectifier circuit and a second output rectifier circuit. The current providing circuit is used for receiving an input voltage and generating a first current or a first voltage, thereby providing electrical energy to the first set of DC loads and the second set of DC loads. The current-sharing circuit is connected with a power output terminal of the current providing circuit, and includes a first current-sharing transformer and a second current-sharing transformer. The first output rectifier circuit is interconnected between the first set of DC loads and a first output terminal of the current-sharing circuit for rectification, thereby generating a first output current to the first set of DC loads. The second output rectifier circuit is interconnected between the second set of DC loads and a second output terminal of the current-sharing circuit for rectification, thereby generating a second output current to the second set of DC loads. The first output current and the second output current are balanced by the current-sharing circuit.

In accordance with a second aspect of the present invention, there is provided a current-sharing supply circuit for driving multiple sets of DC loads. The current-sharing supply circuit includes a current providing circuit, a current-sharing circuit and multiple output rectifier circuits. The current providing circuit is used for receiving an input voltage and generating a first current or a first voltage, thereby providing electrical energy to the first set of DC loads and the second set of DC loads. The current-sharing circuit is connected with power output terminal of the current providing circuit, and includes multiple current-sharing transformer sets and at least a first coupling inductor member. Each current-sharing transformer set comprises at least one layer. The output rectifier circuits are interconnected between respective set of DC loads and the output terminal of the current-sharing circuit for rectification, thereby generating respective output currents to respective set of DC loads. The output currents are balanced by the current-sharing circuit.

In accordance with a third aspect of the present invention, there is provided a current-sharing supply circuit for driving multiple sets of DC loads. The current-sharing supply circuit includes a current providing circuit, a current-sharing circuit and multiple output rectifier circuits. The current providing circuit is used for receiving an input voltage and generating a first current or a first voltage, thereby providing electrical energy to the first set of DC loads and the second set of DC loads. The current-sharing circuit is connected with power output terminal of the current providing circuit, and includes a first current-sharing transformer set. The current-sharing transformer set comprises at least one layer. The output rectifier circuits are interconnected between respective set of DC loads and the output terminal of the current-sharing circuit for rectification, thereby generating respective output currents to respective set of DC loads. The output currents are balanced by the current-sharing circuit.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic circuit diagram of a current-sharing supply circuit for driving multiple LED strings according to the prior art;

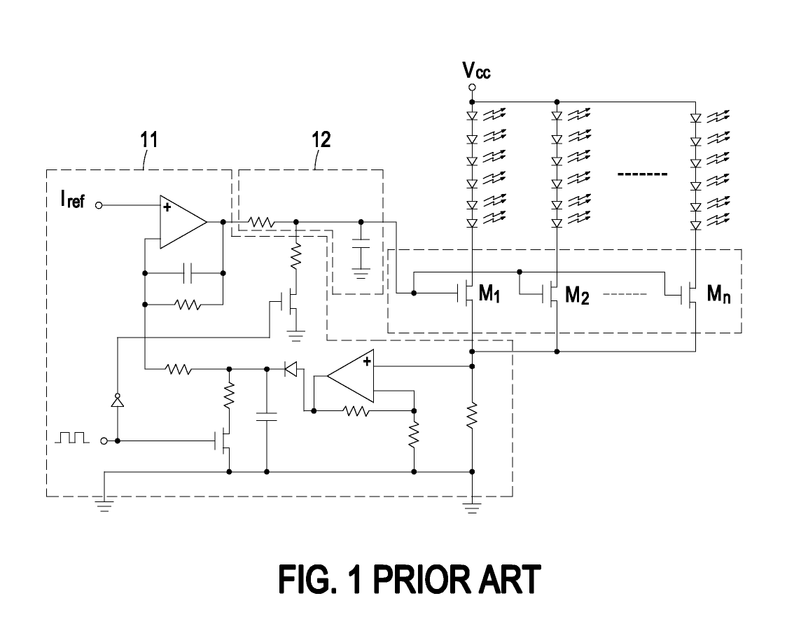

FIG. 2 is a schematic circuit block diagram of a current-sharing supply circuit for driving multiple sets of DC loads according to an embodiment of the present invention;

FIG. 3 is a schematic detailed circuit diagram illustrating the current-sharing supply circuit shown in FIG. 2;

FIG. 4 is a schematic detailed circuit diagram illustrating a variant of the current-sharing supply circuit shown in FIG. 3;

FIG. 5 is a schematic detailed circuit diagram illustrating a variant of the current-sharing supply circuit shown in FIG. 4;

FIG. 6 is a schematic detailed circuit diagram illustrating another variant of the current-sharing supply circuit shown in FIG. 3;

FIG. 7 is a schematic detailed circuit diagram illustrating a variant of the current-sharing supply circuit shown in FIG. 6;

FIG. 8 is a schematic detailed circuit diagram illustrating another variant of the current-sharing supply circuit shown in FIG. 3;

FIG. 9 is a schematic detailed circuit diagram illustrating another variant of the current-sharing supply circuit shown in FIG. 3;

FIG. 10 is a schematic detailed circuit diagram illustrating another exemplary current-sharing circuit; and

FIG. 11 is a schematic detailed circuit diagram illustrating another exemplary current-sharing circuit.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

The present invention relates to a current-sharing supply circuit for driving multiple sets of DC loads, so that all sets of DC loads have the same brightness values. The multiple sets of DC loads include for example multiple LED strings. Each LED string includes a plurality of LEDs. For clarification, two LED strings, each of which has three LEDs, are shown in the drawings.

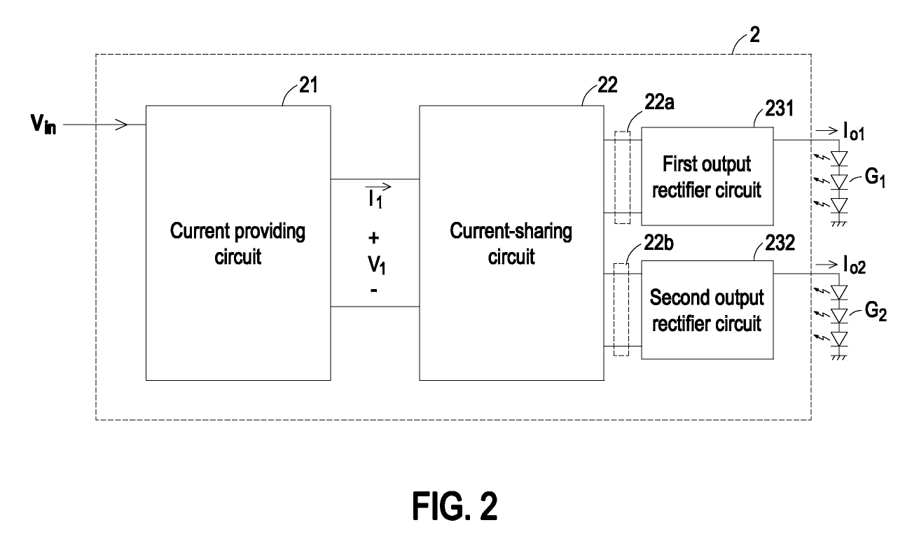

FIG. 2 is a schematic circuit block diagram of a current-sharing supply circuit for driving multiple sets of DC loads according to an embodiment of the present invention. The current-sharing supply circuit 2 is used for driving a first LED string G₁ and a second LED string G₂. As shown in FIG. 2, the current-sharing supply circuit 2 comprises a current providing circuit 21, a current-sharing circuit 22, a first output rectifier circuit 231 and a second output rectifier circuit 232. The power output terminal of the current providing circuit 21 is connected with the input terminal of the current-sharing circuit 22 for receiving an input DC voltage Vᵢₙ and generating a first current I₁ or a first voltage V₁, thereby providing electrical energy to illuminate the first LED string G₁ and the second LED string G₂.

The current-sharing circuit 22 comprises a first current-sharing transformer Tₐ and a second current-sharing transformer T_{b} (not shown). The input terminal of the current-sharing circuit 22 is connected with the power output terminal of the current providing circuit 21 for receiving the first current I₁ or the first voltage V₁, thereby outputting balanced first output current Io₁ and second output current Io₂ to the first LED string G₁ and the second LED string G₂. The input terminal of the first output rectifier circuit 231 is connected with a first output terminal 22a of the current-sharing circuit 22. The output terminal of the first output rectifier circuit 231 is connected with a first end of the first LED string G₁ for rectification, thereby generating the first output current Io₁ to the first LED string G₁. The input terminal of the second output rectifier circuit 232 is connected with a second output terminal 22b of the current-sharing circuit 22. The output terminal of the second output rectifier circuit 232 is connected with a first end of the second LED string G₂ for rectification, thereby generating the second output current Io₂ to the second LED string G₂.

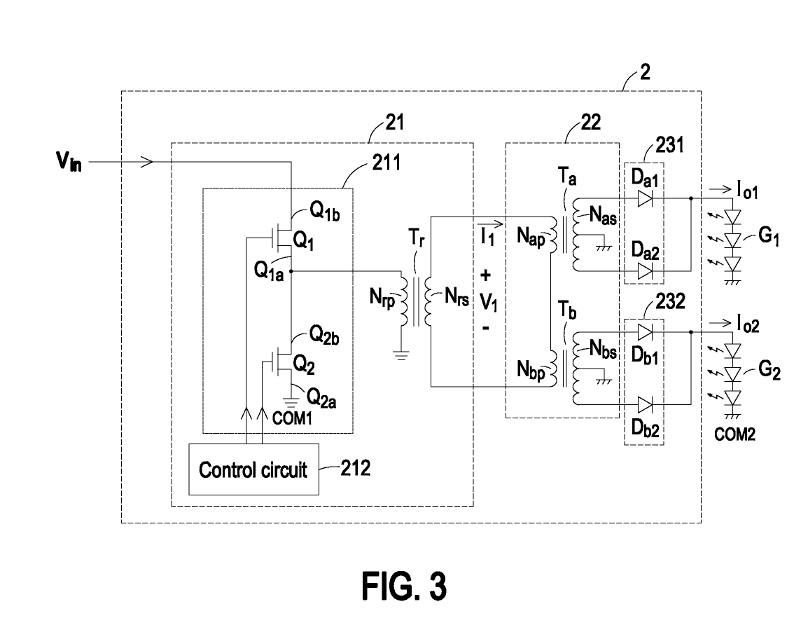

FIG. 3 is a schematic detailed circuit diagram illustrating the current-sharing supply circuit shown in FIG. 2. The current providing circuit 21 comprises a switching circuit 211, a control circuit 212 and an isolation transformer Tᵣ. The power output terminal of the switching circuit 211 is connected with a primary winding assembly Nᵣₚ of the isolation transformer Tᵣ. The control terminal of the switching circuit 211 is connected with the control circuit 212. By the switching circuit 211, the electrical energy of the input DC voltage Vᵢₙ is selectively transmitted to the primary winding assembly Nᵣₚ of the isolation transformer Tᵣ through the switching circuit 211 according to a first pulse width modulation signal V_{PWM1} and a second pulse width modulation signal V_{PWM2} that are outputted from the control circuit 212.

In this embodiment, the switching circuit 211 comprises a first switch element Q₁ and a second switch element Q₂. A first end Q₁ₐ of the first switch element Q₁ is connected with a first end of the primary winding assembly Nᵣₚ and a second end Q_{2b} of the second switch element Q₂. A first end Q₂ₐ of the second switch element Q₂ is connected with a common terminal COM₁. The second end of the primary winding assembly Nᵣₚ is also connected with the common terminal COM₁. The control terminals of the first switch element Q₁ and the second switch element Q₂ are connected with the control circuit 212. Under control of the control circuit 212, the first switch element Q₁ and the second switch element Q₂ are selectively conducted or shut off according to the first pulse width modulation signal V_{PWM1} and the second pulse width modulation signal V_{PWM2}, respectively. As a consequence, the electrical energy of the input DC voltage Vᵢₙ is selectively transmitted to the primary winding assembly Nᵣₚ of the isolation transformer Tᵣ through the second end Q_{1b} of the first switch element Q₁ or the first end Q₂ₐ of the second switch element Q₂. As such, both ends of the primary winding assembly Nᵣₚ are subject to a voltage variation. Due to the voltage variation, a secondary winding assembly Nᵣₛ of the isolation transformer Tᵣ generates the first current I₁ or the first voltage V₁.

In this embodiment, the current-sharing circuit 22 comprises a first current-sharing transformer Tₐ and a second current-sharing transformer T_{b} (not shown). The first output rectifier circuit 231 comprises a first main diode Dₐ₁ and a first minor diode Dₐ₂. The second output rectifier circuit 232 comprises a second main diode D_{b2} and a second minor diode D_{b2}. The primary winding assembly Nₐₚ of the first current-sharing transformer Tₐ and the primary winding assembly N_{bp} of the second current-sharing transformer T_{b} are serially connected with the power output terminal of the current providing circuit 21. Both ends of the secondary winding assembly Nₐₛ of the first current-sharing transformer Tₐ are respectively connected with the anodes of the first main diode Dₐ₁ and the first minor diode Dₐ₂. The cathodes of the first main diode Dₐ₁ and the first minor diode Dₐ₂ are connected with an anode of the first LED string G₁. The cathode of the first LED string G₁ and the center-tapped head of the secondary winding assembly Nₐₛ of the first current-sharing transformer Tₐ are connected with a second command terminal COM2. Both ends of the secondary winding assembly N_{bs} of the second current-sharing transformer T_{b} are respectively connected with the anodes of the second main diode D_{b1} and the second minor diode D_{b2}. The cathodes of the second main diode D_{b1} and the second minor diode D_{b2} are connected with an anode of the second LED string G₂. The cathode of the second LED string G₂ and the center-tapped head of the secondary winding assembly N_{bs} of the second current-sharing transformer T_{b} are connected with the second command terminal COM2.

Since the primary winding assembly Nₐₚ of the first current-sharing transformer Tₐ and the primary winding assembly N_{bp} of the second current-sharing transformer T_{b} are serially connected with the power output terminal of the current providing circuit 21, the current passing through the primary winding assembly Nₐₚ and the primary winding assembly N_{bp} are identical and equal to the first current I₁. As such, the electrical energy of the primary winding assembly Nₐₚ and the electrical energy of the primary winding assembly N_{bp} are magnetically transmitted to the secondary winding assembly Nₐₛ and the secondary winding assembly N_{bs}, thereby generating the first output current Io₁ and the second output current Io₂ to the first LED string G₁ and the second LED string G₂, in which the first current I₁ is equal to the second output current IO₂.

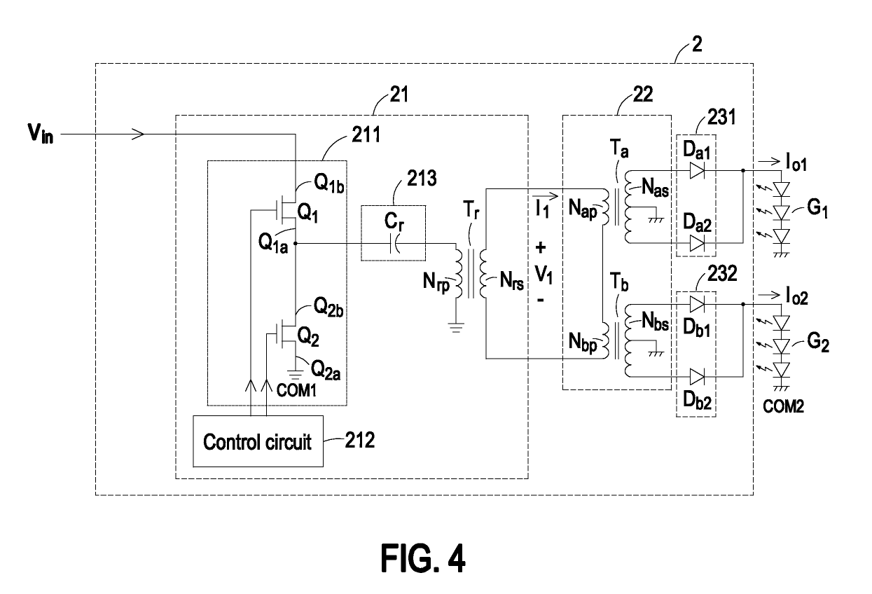

FIG. 4 is a schematic detailed circuit diagram illustrating a variant of the current-sharing supply circuit shown in FIG. 3. In comparison with FIG. 3, the current providing circuit 21 of FIG. 4 further comprises a resonant circuit 213. The resonant circuit 213 is interconnected between the power output terminal of the switching circuit 211 and the primary winding assembly Nᵣₚ of the isolation transformer Tᵣ. The resonant circuit 213 includes a resonant capacitor Cᵣ. The resonant capacitor Cᵣ is serially connected between the power output terminal of the switching circuit 211 and the primary winding assembly Nᵣₚ of the isolation transformer Tᵣ. Due to a resonant relation between the resonant capacitor Cᵣ and the primary winding assembly Nᵣₚ of the isolation transformer Tᵣ, the both ends of the primary winding assembly Nᵣₚ are subject to a voltage variation. Due to the voltage variation, the secondary winding assembly Nᵣₛ of the isolation transformer Tᵣ generates the first current I₁ or the first voltage V₁.

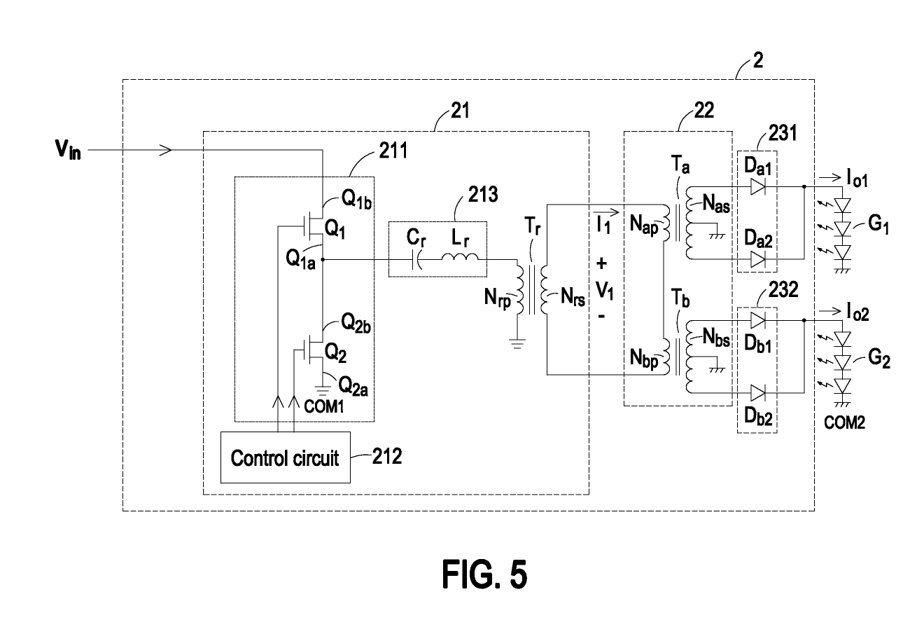

FIG. 5 is a schematic detailed circuit diagram illustrating a variant of the current-sharing supply circuit shown in FIG. 4. In comparison with FIG. 4, the resonant circuit 213 of FIG. 5 further comprises a resonant inductor Lᵣ. The resonant inductor Lᵣ and the resonant capacitor Cᵣ are serially connected between the power output terminal of the switching circuit 211 and the primary winding assembly Nᵣₚ of the isolation transformer Tᵣ. Due to a resonant relation between the resonant inductor Lᵣ, the resonant capacitor Cᵣ and the primary winding assembly Nᵣₚ of the isolation transformer Tᵣ, the both ends of the primary winding assembly Nᵣₚ are subject to a voltage variation. Due to the voltage variation, the secondary winding assembly Nᵣₛ of the isolation transformer Tᵣ generates the first current I₁ or the first voltage V₁.

In accordance with the present invention, the isolation transformer Tᵣ is designed to create a resonant relation between the primary winding assembly Nᵣₚ of the isolation transformer Tᵣ and the resonant circuit 213. The resonant frequency is for example 30 kHz. The resonant relation between the isolation transformer Tᵣ and the resonant circuit 213 has nothing to do with the first current-sharing transformer Tₐ and the second current-sharing transformer T_{b}. In other words, the structures of first current-sharing transformer Tₐ and the second current-sharing transformer T_{b} could be as simply as possible. According to the magnitudes of the first output current Io₁ and the second output current Io₂, the structures of the first current-sharing transformer Tₐ and the second current-sharing transformer T_{b} could be easily designed. As such, the first output current Io₁ is equal to the second output current Io₂.

In the current-sharing supply circuit 2, the isolation effect is provided by the isolation transformer Tᵣ rather than the first current-sharing transformer Tₐ and the second current-sharing transformer T_{b}. In other words, the first current-sharing transformer Tₐ and the second current-sharing transformer T_{b} could be designed as small-sized transformers without isolation effects. In other words, since the overall volume of the current-sharing supply circuit 2 is reduced but the circuitry density is enhanced, the current-sharing supply circuit 2 is feasible to be used in small-sized electronic devices (e.g. slim-type TV sets, slim-type screens or slim-type notebook computer) that have LEDs as backlight sources.

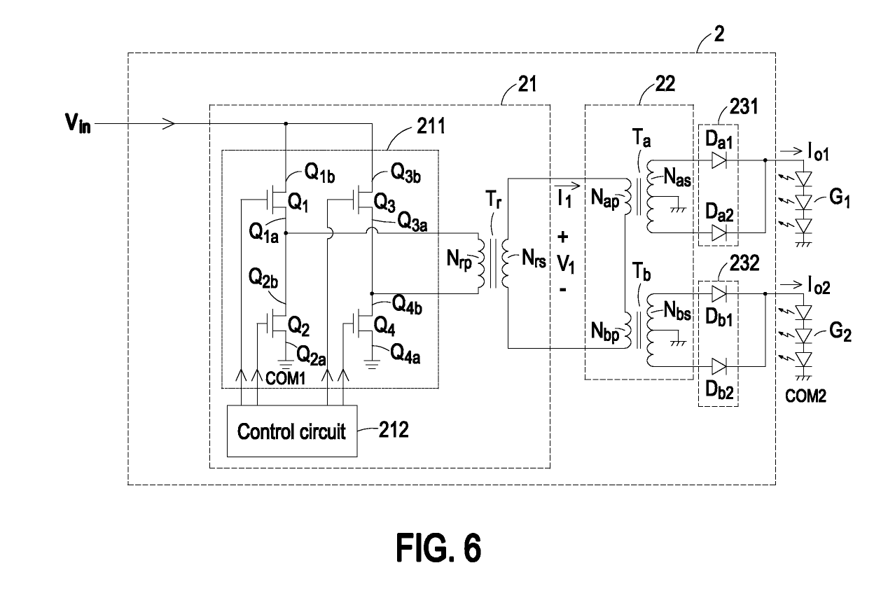

FIG. 6 is a schematic detailed circuit diagram illustrating another variant of the current-sharing supply circuit shown in FIG. 3. In comparison with FIG. 3, the switching circuit 211 of FIG. 6 further comprises a third switch element Q₃ and a fourth switch element Q₄. The first end of the primary winding assembly Nᵣₚ of the isolation transformer Tᵣ is connected with the first end Q₁ₐ of the first switch element Q₁ and the second end Q_{2b} of the second switch element Q₂. The second end of the primary winding assembly Nᵣₚ of the isolation transformer Tᵣ is connected with a first end Q₃ₐ of the third switch element Q₃ and a second end Q_{4b} of the fourth switch element Q₄. The first end Q₄ₐ of the fourth switch element Q₄ is connected with the first common terminal COM₁. The second end Q_{3b} of the third switch element Q₃ is connected with the second end Q_{1b} of the first switch element Q₁. The control terminals of the third switch element Q₃ and the fourth switch element Q₄ are connected with the control circuit 212. Under control of the control circuit 212, the first switch element Q₁, the second switch element Q₂, the third switch element Q₃ and the fourth switch element Q₄ are selectively conducted or shut off according to the first pulse width modulation signal V_{PWM1}, the second pulse width modulation signal V_{PWM2}, the third pulse width modulation signal V_{PWM3} and the fourth pulse width modulation signal V_{PWM4}, respectively. As a consequence, the electrical energy of the input DC voltage Vᵢₙ is selectively transmitted to the primary winding assembly Nᵣₚ of the isolation transformer Tᵣ through the first witch element Q₁, the second switch element Q₂, the third switch element Q₃ and the fourth switch element Q₄. As such, both ends of the primary winding assembly Nᵣₚ are subject to a voltage variation. Due to the voltage variation, a secondary winding assembly Nᵣₛ of the isolation transformer Tᵣ generates the first current I₁ or the first voltage V₁.

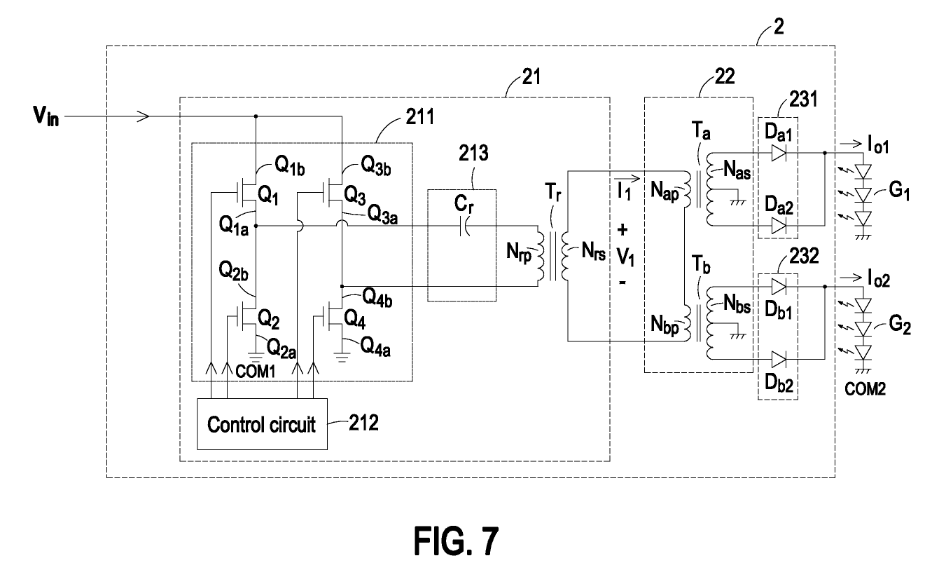

FIG. 7 is a schematic detailed circuit diagram illustrating a variant of the current-sharing supply circuit shown in FIG. 6. In comparison with FIG. 6, the current providing circuit 21 of FIG. 7 further comprises a resonant circuit 213. The resonant circuit 213 is interconnected between the power output terminal of the switching circuit 211 and the primary winding assembly Nᵣₚ of the isolation transformer Tᵣ. The resonant circuit 213 includes a resonant capacitor Cᵣ. A first end of the resonant capacitor Cᵣ is connected with the first end Q₁ₐ of the first switch element Q₁ and the second end Q_{2b} of the second switch element Q₂. A second end of the resonant capacitor Cᵣ is connected with the primary winding assembly Nᵣₚ of the isolation transformer Tᵣ. That is, the resonant capacitor Cᵣ is serially connected between the power output terminal of the switching circuit 211 and the primary winding assembly Nᵣₚ of the isolation transformer Tᵣ. Due to a resonant relation between the resonant capacitor Cᵣ and the primary winding assembly Nᵣₚ of the isolation transformer Tᵣ, the both ends of the primary winding assembly Nᵣₚ are subject to a voltage variation. Due to the voltage variation, the secondary winding assembly Nᵣₛ of the isolation transformer Tᵣ generates the first current I₁ or the first voltage V₁.

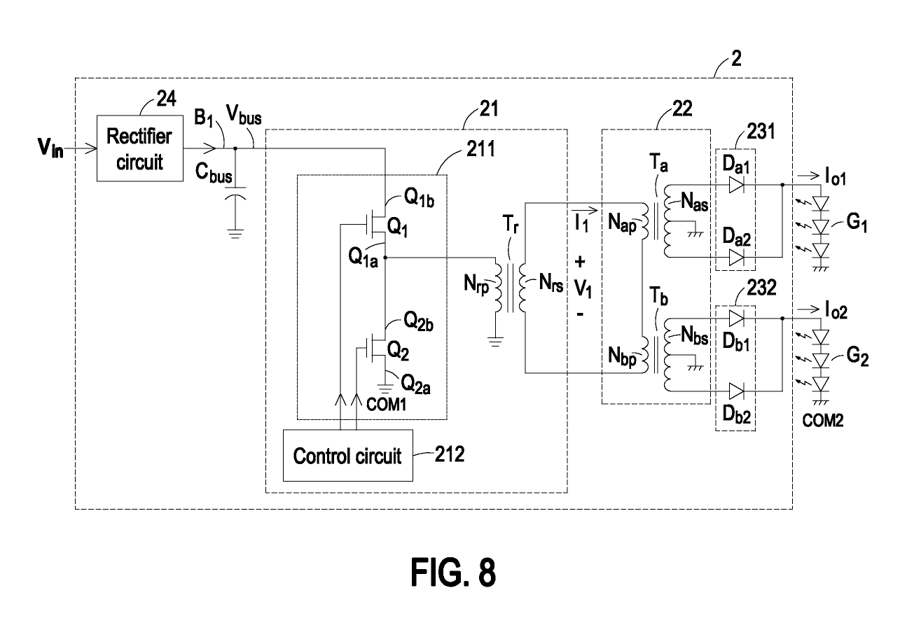

FIG. 8 is a schematic detailed circuit diagram illustrating another variant of the current-sharing supply circuit shown in FIG. 3. In comparison with FIG. 3, the current-sharing supply circuit 2 of FIG. 8 further comprises a rectifier circuit 24 and a bus capacitor _{bus.} The output terminal of the rectifier circuit 24 is connected with a first end of the bus capacitor C_{bus} through a bus B₁ and the power input terminal of the current providing circuit 21. The rectifier circuit 24 is used for rectifying an input AC voltage Vᵢₙ into a bus voltage V_{bus}, which is transmitted to the power input terminal of the current providing circuit 21. A second end of the bus capacitor C_{bus} is connected with the first common terminal COM₁. The bus capacitor C_{bus} is used for filtering and storing electrical energy.

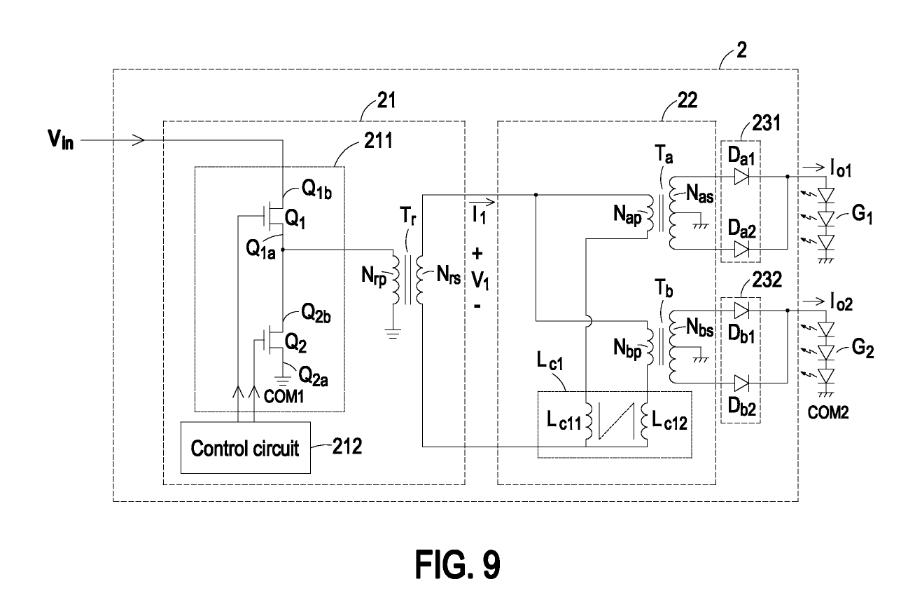

FIG. 9 is a schematic detailed circuit diagram illustrating another variant of the current-sharing supply circuit shown in FIG. 3. In comparison with FIG. 3, the current-sharing circuit 22 of FIG. 9 further comprises a first coupling inductor member L_{c1}, and the connection between the primary winding assembly Nₐₚ of the first current-sharing transformer Tₐ and the primary winding assembly N_{bp} of the second current-sharing transformer T_{b} is distinguished. As shown in FIG. 9, the first coupling inductor member L_{c1} comprises multiple inductors (e.g. a first inductor L_{c11} and a second inductor L_{c12}). The first inductor L_{c11} of the first coupling inductor member L_{c1} is serially connected with the primary winding assembly Nₐₚ of the first current-sharing transformer Tₐ. The first coupling inductor member L_{c1} and the primary winding assembly Nₐₚ are collectively connected with the power output terminals of the current providing circuit 21 in parallel. Similarly, the second inductor L_{c12} is serially connected with the primary winding assembly N_{bp} of the second current-sharing transformer T_{b}. The second inductor L_{c12} and the primary winding assembly N_{bp} are collectively connected with the power output terminals of the current providing circuit 21 in parallel.

Since the first inductor L_{c11} and the second inductor L_{c12} are coupled with each other, the same current passes through the first inductor L_{c11} and the second inductor L_{c12}. In other words, the currents passing through the primary winding assembly Nₐₚ of the first current-sharing transformer Tₐ and the primary winding assembly N_{bp} of the second current-sharing transformer T_{b} are identical. Even if the primary winding assembly Nₐₚ of the first current-sharing transformer Tₐ and the primary winding assembly N_{bp} of the second current-sharing transformer T_{b} are not connected in series, the currents passing through the primary winding assembly Nₐₚ of the first current-sharing transformer Tₐ and the primary winding assembly N_{bp} of the second current-sharing transformer T_{b} are identical because the primary winding assembly Nₐₚ and the primary winding assembly Nₐₚ are respectively connected with the first inductor L_{c11} and the second inductor L_{c12} in series. As such, the electrical energy of the primary winding assembly Nₐₚ and the electrical energy of the primary winding assembly N_{bp} are magnetically transmitted to the secondary winding assembly Nₐₛ and the secondary winding assembly N_{bs}, thereby generating the first output current Io₁ and the second output current Io₂ to the first LED string G₁ and the second LED string G₂, in which the first current I₁ is equal to the second output current Io₂.

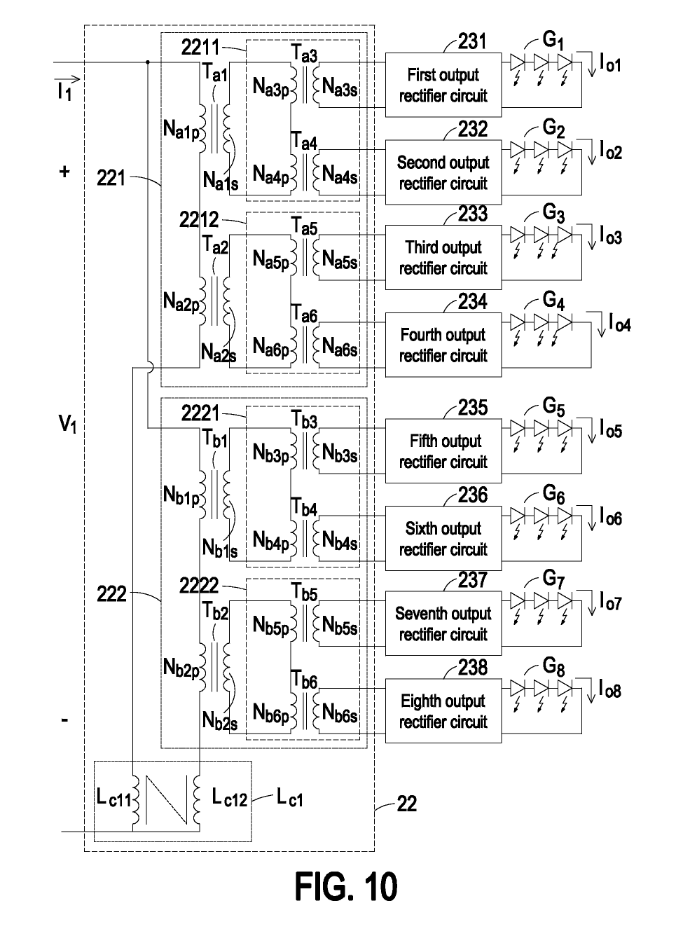

FIG. 10 is a schematic detailed circuit diagram illustrating another exemplary current-sharing circuit. The current-sharing circuit 22 comprises multiple current-sharing transformer sets and at least one coupling inductor member. Each current-sharing transformer set comprises multiple layers. As shown in FIG. 10, the current-sharing circuit 22 comprises a first current-sharing transformer set 221, a second current-sharing transformer set 222 and a first coupling inductor member L_{c1}. The first coupling inductor member L_{c1} comprises multiple inductors (e.g. a first inductor L_{c11} and a second inductor L_{c12}). Each of the first current-sharing transformer set 221 and the second current-sharing transformer set 222 has two layers.

The first layer of the first current-sharing transformer set 221 comprises a first current-sharing transformer Tₐ₁ and a second current-sharing transformer Tₐ₂. The primary winding assembly Nₐ₁ₚ of the first current-sharing transformer Tₐ₁, the primary winding assembly Nₐ₂ₚ of the second current-sharing transformer Tₐ₂ and the first inductor L_{c11} of the first coupling inductor member L_{c1} are serially connected with the power output terminal (not shown) of the current providing circuit 21. The secondary winding assembly Nₐ₁ₛ of the first current-sharing transformer Tₐ₁ is connected with a first current-sharing branch 2211. The secondary winding assembly Nₐ₂ₛ of the second current-sharing transformer Tₐ₂ is connected with a second current-sharing branch 2212.

The second layer of the first current-sharing transformer set 221 comprises the first current-sharing branch 2211 and the second current-sharing branch 2212. The first current-sharing branch 2211 comprises a third current-sharing transformer Tₐ₃ and a fourth current-sharing transformer Tₐ₄. The primary winding assembly Nₐ₃ₚ of the third current-sharing transformer Tₐ₃ and the primary winding assembly Nₐ₄ₚ of the fourth current-sharing transformer Tₐ₄ are serially connected with the secondary winding assembly Nₐ₁ₛ of the first current-sharing transformer Tₐ₁ of the former layer (i.e. the first layer). The second current-sharing branch 2212 comprises a fifth current-sharing transformer Tₐ₅ and a sixth current-sharing transformer Tₐ₆. The primary winding assembly Nₐ₅ₚ of the fifth current-sharing transformer Tₐ₅ and the primary winding assembly Nₐ₆ₚ of the sixth current-sharing transformer Tₐ₆ are serially connected with the secondary winding assembly Nₐ₂ₛ of the second current-sharing transformer Tₐ₂ of the former layer.

In the last layer (i.e. the second layer) of the first current-sharing transformer set 221, the secondary winding assembly Nₐ₃ₛ of the third current-sharing transformer Tₐ₃, the secondary winding assembly Nₐ₄ₛ of the fourth current-sharing transformer Tₐ₄, the secondary winding assembly Nₐ₅ₛ of the fifth current-sharing transformer Tₐ₅ and the secondary winding assembly Nₐ₆ₛ of the sixth current-sharing transformer Tₐ₆ are respectively connected with a first output rectifier circuit 231, a second output rectifier circuit 232, a third output rectifier circuit 233 and a fourth output rectifier circuit 234.

The first layer of the second current-sharing transformer set 222 comprises a first current-sharing transformer T_{b1} and a second current-sharing transformer T_{b2}. The primary winding assembly N_{b1p} of the first current-sharing transformer T_{b1}, the primary winding assembly N_{b2p} of the second current-sharing transformer T_{b2} and the second inductor L_{c12} of the first coupling inductor member L_{c1} are serially connected with the power output terminal (not shown) of the current providing circuit 21. The secondary winding assembly N_{b1s} of the first current-sharing transformer T_{b1} is connected with a first current-sharing branch 2221. The secondary winding assembly N_{b2s} of the second current-sharing transformer T_{b2} is connected with a second current-sharing branch 2222.

The second layer of the second current-sharing transformer set 222 comprises the first current-sharing branch 2221 and the second current-sharing branch 2222. The first current-sharing branch 2221 comprises a third current-sharing transformer T_{b3} and a fourth current-sharing transformer T_{b4}. The primary winding assembly N_{b3p} of the third current-sharing transformer T_{b3} and the primary winding assembly N_{b4p} of the fourth current-sharing transformer T_{b4} are serially connected with the secondary winding assembly N_{b1s} of the first current-sharing transformer T_{b1} of the former layer (i.e. the first layer). The second current-sharing branch 2222 comprises a fifth current-sharing transformer T_{b5} and a sixth current-sharing transformer T_{b6}. The primary winding assembly N_{b5p} of the fifth current-sharing transformer T_{b5} and the primary winding assembly N_{b6p} of the sixth current-sharing transformer T_{b6} are serially connected with the secondary winding assembly N_{b2s} of the second current-sharing transformer T_{b2} of the former layer.

In the last layer (i.e. the second layer) of the second current-sharing transformer set 222, the secondary winding assembly N_{b3s} of the third current-sharing transformer T_{b3}, the secondary winding assembly N_{b4s} of the fourth current-sharing transformer T_{b4}, the secondary winding assembly N_{b5s} of the fifth current-sharing transformer T_{b5} and the secondary winding assembly N_{b6s} of the sixth current-sharing transformer T_{b6} are respectively connected with a fifth output rectifier circuit 235, a sixth output rectifier circuit 236, a seventh output rectifier circuit 237 and an eighth output rectifier circuit 238.

Since the first inductor L_{c11} and the second inductor L_{c12} are coupled with each other, the same current passes through the first inductor L_{c11} and the second inductor L_{c12}. In other words, the currents passing through the primary winding assembly Nₐ₁ₚ of the first current-sharing transformer Tₐ₁ of the first layer of the first current-sharing transformer set 221, the primary winding assembly Nₐ₂ₚ of the second current-sharing transformer Tₐ₂ of the first layer of the first current-sharing transformer set 221, the primary winding assembly N_{b1p} of the first current-sharing transformer T_{b1} of the first layer of the second current-sharing transformer set 222 and the primary winding assembly N_{b2p} of the second current-sharing transformer T_{b2} of the first layer of the second current-sharing transformer set 222 are identical. Correspondingly, the current outputted from the secondary winding assembly Nₐ₁ₛ of the first current-sharing transformer Tₐ₁ of the first layer of the first current-sharing transformer set 221 to the first current-sharing branch 2211, the current outputted from the secondary winding assembly Nₐ₂ₛ of the second current-sharing transformer Tₐ₂ of the first layer of the first current-sharing transformer set 221 to the second current-sharing branch 2212, the current outputted from the secondary winding assembly N_{b1s} of the first current-sharing transformer T_{b1} of the first layer of the second current-sharing transformer set 222 to the first current-sharing branch 2221, and the current outputted from the secondary winding assembly N_{b2s} of the second current-sharing transformer T_{b2} of the first layer of the second current-sharing transformer set 222 to the second current-sharing branch 2222 are identical.

In the first current-sharing branch 2211 of the first current-sharing transformer set 221, the primary winding assembly Nₐ₃ₚ of the third current-sharing transformer Tₐ₃ and the primary winding assembly Nₐ₄ₚ of the fourth current-sharing transformer Tₐ₄ are serially connected with each other, so that the first output current Io₁ passing through the first LED string G₁ and the second output current Io₂ passing through the second LED string G₂ are identical. In the second current-sharing branch 2212 of the first current-sharing transformer set 221, the primary winding assembly Nₐ₅ₚ of the fifth current-sharing transformer ₐ₅ and the primary winding assembly Nₐ₆ₚ of the sixth current-sharing transformer Tₐ₆ are serially connected with each other, so that the third output current Io₃ passing through the third LED string G₃ and the fourth output current Io₄ passing through the fourth LED string G₄ are identical.

In the first current-sharing branch 2221 of the second current-sharing transformer set 222, the primary winding assembly N_{b3p} of the third current-sharing transformer T_{b3} and the primary winding assembly N_{b4p} of the fourth current-sharing transformer T_{b4} are serially connected with each other, so that the fifth output current Io₅ passing through the fifth LED string G₅ and the sixth output current Io₆ passing through the sixth LED string G₆ are identical. In the second current-sharing branch 2222 of the second current-sharing transformer set 222, the primary winding assembly N_{b5p} of the fifth current-sharing transformer T_{b5} and the primary winding assembly N_{b6p} of the sixth current-sharing transformer T_{b6} are serially connected with each other, so that the seventh output current Io₇ passing through the seventh LED string G₇ and the eighth output current Io₈ passing through the eighth LED string G₈ are identical.

The currents passing through the secondary winding assembly Nₐ₁ₛ of the first current-sharing transformer Tₐ₁ of the first layer of the first current-sharing transformer set 221, the secondary winding assembly Nₐ₂ₛ of the second current-sharing transformer Tₐ₂ of the first layer of the first current-sharing transformer set 221, the secondary winding assembly N_{b1s} of the first current-sharing transformer T_{b1} of the first layer of the second current-sharing transformer set 222 and the secondary winding assembly N_{b2s} of the second current-sharing transformer T_{b2} of the first layer of the second current-sharing transformer set 222 are identical. Correspondingly, the first output current Io₁ outputted from the first current-sharing branch 2211 to the first LED string G₁ through the first output rectifier circuit 231, the second output current Io₂ outputted from the first current-sharing branch 2211 to the second LED string G₂ through the second output rectifier circuit 232, the third output current Io₃ outputted from the second current-sharing branch 2212 to the third LED string G₃ through the third output rectifier circuit 233, the fourth output current Io₄ outputted from the second current-sharing branch 2212 to the fourth LED string G₄ through the fourth output rectifier circuit 234, the fifth output current Io₅ outputted from the first current-sharing branch 2221 to the fifth LED string G₅ through the fifth output rectifier circuit 235, the sixth output current Io₆ outputted from the first current-sharing branch 2221 to the sixth LED string G₆ through the sixth output rectifier circuit 236, the seventh output current Io₃ outputted from the second current-sharing branch 2222 to the seventh LED string G₇ through the seventh output rectifier circuit 237, and the eighth output current Io₈ outputted from the second current-sharing branch 2222 to the eighth LED string G₈ through the eighth output rectifier circuit 238 are identical.

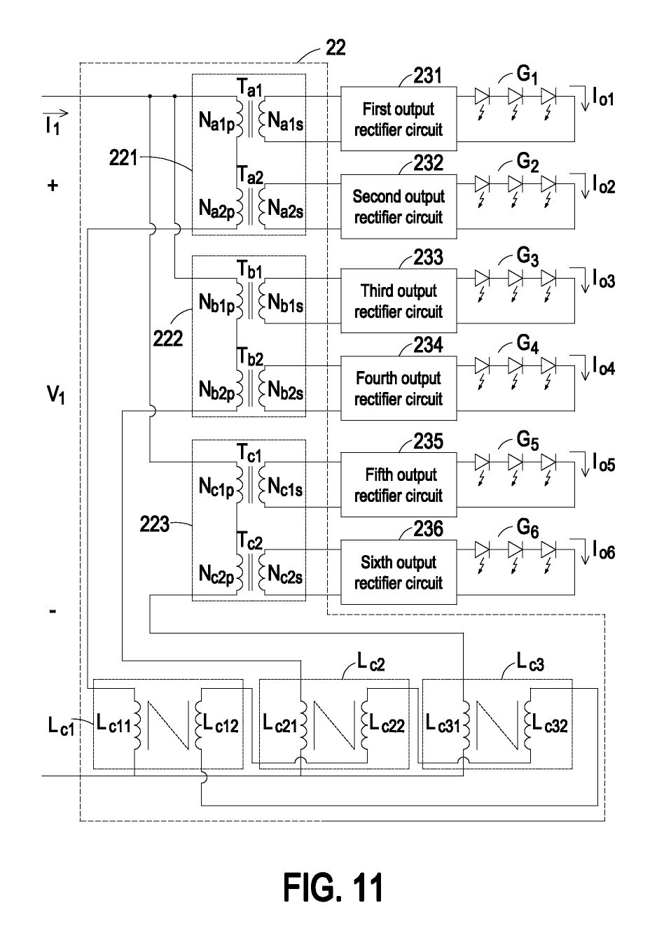

FIG. 11 is a schematic detailed circuit diagram illustrating another exemplary current-sharing circuit. The current-sharing circuit 22 comprises multiple current-sharing transformer sets and multiple coupling inductor members. Each current-sharing transformer set comprises at least one layer. As shown in FIG. 11, the current-sharing circuit 22 comprises a first current-sharing transformer set 221, a second current-sharing transformer set 222, a third current-sharing transformer set 223, a first coupling inductor member L_{c1}, a second coupling inductor member L_{c2} and a third coupling inductor member L_{c3}. The first coupling inductor member L_{c1} comprises a first inductor L_{c11} and a second inductor L₁₂. The second coupling inductor member L_{c2} comprises a third inductor L_{c21} and a fourth inductor L_{c22}. The third coupling inductor member L_{c3} comprises a fifth inductor L_{c31} and a sixth inductor L_{c32}.

The first layer of the first current-sharing transformer set 221 comprises a first current-sharing transformer Tₐ₁ and a second current-sharing transformer Tₐ₂. The primary winding assembly Nₐ₁ₚ of the first current-sharing transformer Tₐ₁, the primary winding assembly Nₐ₂ₚ of the second current-sharing transformer Tₐ₂ and the first inductor of the first coupling inductor member L_{c1} are serially connected with the power output terminal (not shown) of the current providing circuit 21. The secondary winding assembly Nₐ₁ₛ of the first current-sharing transformer Tₐ₁ is connected with a first output rectifier circuit 231. The secondary winding assembly Nₐ₂ₛ of the second current-sharing transformer Tₐ₂ is connected with a second output rectifier circuit 232.

The first layer of the second current-sharing transformer set 222 comprises a first current-sharing transformer T_{b1} and a second current-sharing transformer T_{b2}. The primary winding assembly N_{b1p} of the first current-sharing transformer T_{b1}, the primary winding assembly N_{b2p} of the second current-sharing transformer T_{b2} and the third inductor L_{c21} of the second coupling inductor member L_{c2} are serially connected with the power output terminal (not shown) of the current providing circuit 21. The secondary winding assembly N_{b1s} of the first current-sharing transformer Tₐ₁ is connected with a third output rectifier circuit 233. The secondary winding assembly N_{b2s} of the second current-sharing transformer T_{b2} is connected with a fourth output rectifier circuit 234.

The first layer of the third current-sharing transformer set 223 comprises a first current-sharing transformer T_{c1} and a second current-sharing transformer T_{c2}. The primary winding assembly N_{c1p} of the first current-sharing transformer T_{c1}, the primary winding assembly N_{c2p} of the second current-sharing transformer T_{c2} and the fifth inductor L_{c31} of the third coupling inductor member L_{c3} are serially connected with the power output terminal (not shown) of the current providing circuit 21. The secondary winding assembly N_{c1s} of the first current-sharing transformer T_{c1} is connected with a fifth output rectifier circuit 235. The secondary winding assembly N_{c2s} of the second current-sharing transformer T_{c2} is connected with a sixth output rectifier circuit 236.

Since the second inductor L_{c12}, the fourth inductor L_{c22} and the sixth inductor L_{c32} are connected with each other in series, the currents passing through the second inductor L_{c12}, the fourth inductor L_{c22} and the sixth inductor L_{c32} are identical. Since the first inductor L_{c11} and the second inductor L_{c12} are coupled with each other, the third inductor L_{c21} and the fourth inductor L_{c22} are coupled with each other and the fifth inductor L_{c31} and the sixth inductor L_{c32} are coupled with each other, the currents passing through the second inductor L_{c12}, the fourth inductor L_{c22}, the sixth inductor L_{c32} are identical. Correspondingly, the first output current Io₁ outputted from the secondary winding assembly Nₐ₁ₛ of the first current-sharing transformer Tₐ₁ to the first LED string G₁ through the first output rectifier circuit 231, the second output current Io₂ outputted from the secondary winding assembly Nₐ₂ₛ of the second current-sharing transformer Tₐ₂ to the second LED string G₂ through the second output rectifier circuit 232, the third output current Io₃ outputted from the secondary winding assembly N_{b1s} of the first current-sharing transformer T_{b1} to the third LED string G₃ through the third output rectifier circuit 233, the fourth output current Io₄ outputted from the secondary winding assembly N_{b2s} of the second current-sharing transformer T_{b2} to the fourth LED string G₄ through the fourth output rectifier circuit 234, the fifth output current Io₅ outputted from the secondary winding assembly N_{c1s} of the first current-sharing transformer T_{c1} to the fifth LED string G₅ through the fifth output rectifier circuit 235, and the sixth output current Io₆ outputted from the secondary winding assembly N_{c2s} of the second current-sharing transformer T_{c2} to the sixth LED string G₆ through the sixth output rectifier circuit 236 are identical.

In some embodiments, the turn ratio of the primary winding coil to the secondary winding coil for each current-sharing transformer of the current-sharing circuit 22 is equal to 1:1. Alternatively, the turn ratio of the primary winding coil to the secondary winding coil for each current-sharing transformer is adjusted according to the output currents. In some embodiments, the inductance ratio of the first inductor L_{c11} to the second inductor L_{c12}, the inductance ratio of the third inductor L_{c21} to the fourth inductor L₂₂, and the inductance ratio of the fifth inductor L_{c31} to the sixth inductor L_{c32} are equal to 1:1. Alternatively, the inductance ratio is adjusted according to the output currents.

In the above embodiments, an example of the first switch element Q₁, the second switch element Q₂, the third switch element Q₃ or the fourth switch element Q₄ includes but is not limited to a metal oxide semiconductor field effect transistor (MOSFET) or a bipolar junction transistor (BJT). An example of the control circuit 212 includes but is not limited to a digital signal processor (DSP), a micro processor, a pulse width modulation (PWM) controller, or a pulse frequency modulation (PFM) controller. An example of the first output rectifier circuit 231, the second output rectifier circuit 232, the third output rectifier circuit 233, the fourth output rectifier circuit 234, the fifth output rectifier circuit 235, the sixth output rectifier circuit 236, the seventh output rectifier circuit 237 or the eighth output rectifier circuit 238 includes but is not limited to a bridge rectifier circuit, a full-wave rectifier circuit or a half-wave rectifier circuit.

From the above embodiment, the current-sharing supply circuit of the present invention is capable of balancing the currents passing through all sets of DC loads and thus all sets of DC loads have the same brightness values. In addition, the current-sharing supply circuit of the present invention has minimized power loss and high operating efficiency. Since the circuitry configuration is simplified, the current sharing supply circuit is more cost-effective.

Moreover, since the current-sharing transformers are not restricted by the resonant relation between the resonant circuit and the isolation transformer, the current-sharing transformers could be designed as small-sized transformers. Since the overall volume of the current-sharing supply circuit is reduced but the circuitry density is enhanced, the current-sharing supply circuit is feasible to be used in small-sized electronic devices (e.g. slim-type TV sets, slim-type screens or slim-type notebook computer) that have LEDs as backlight sources.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A current-sharing supply circuit for driving a first set of DC loads and a second set of DC loads, said current-sharing supply circuit comprising:
a current providing circuit for receiving an input voltage and generating a first current or a first voltage, thereby providing electrical energy to said first set of DC loads and said second set of DC loads;
a current-sharing circuit connected with a power output terminal of said current providing circuit, and comprising a first current-sharing transformer and a second current-sharing transformer;
a first output rectifier circuit interconnected between said first set of DC loads and a first output terminal of said current-sharing circuit for rectification, thereby generating a first output current to said first set of DC loads; and
a second output rectifier circuit interconnected between said second set of DC loads and a second output terminal of said current-sharing circuit for rectification, thereby generating a second output current to said second set of DC loads,
wherein said first output current and said second output current are balanced by said current-sharing circuit.

2. The current-sharing supply circuit according to claim 1 wherein a primary winding assembly of said first current-sharing transformer and a primary winding assembly of said second current-sharing transformer are serially connected with said power output terminal of the current providing circuit, a secondary winding assembly of said first current-sharing transformer is connected with said first output rectifier circuit through a first output terminal of said current-sharing circuit, and a secondary winding assembly of said second current-sharing transformer is connected with said second output rectifier circuit through a second output terminal of said current-sharing circuit.

3. The current-sharing supply circuit according to claim 1 wherein said current-sharing circuit further comprises a coupling inductor member including a first inductor and a second inductor, said first inductor and a primary winding assembly of said first current-sharing transformer are serially connected with said power output terminal of said current providing circuit, said second inductor and a primary winding assembly of said second current-sharing transformer are serially connected with said power output terminal of said current providing circuit, a secondary winding assembly of said first current-sharing transformer is connected with said first output rectifier circuit through a first output terminal of said current-sharing circuit, and a secondary winding assembly of said second current-sharing transformer is connected with said second output rectifier circuit through a second output terminal of said current-sharing circuit.

4. The current-sharing supply circuit according to claim 1 wherein said first output rectifier circuit comprises:
a first main diode having an anode connected with a first end of said secondary winding assembly of said first current-sharing transformer and a cathode connected with said first set of DC loads; and
a first minor diode having an anode connected with a second end of said secondary winding assembly of said first current-sharing transformer and a cathode connected with said first set of DC loads.

5. The current-sharing supply circuit according to claim 1 said second output rectifier circuit comprises:
a second main diode having an anode connected with a first end of said secondary winding assembly of said second current-sharing transformer and a cathode connected with said second set of DC loads; and
a second minor diode having an anode connected with a second end of said secondary winding assembly of said second current-sharing transformer and a cathode connected with said second set of DC loads

6. The current-sharing supply circuit according to claim 1 wherein a center-tapped head of said first current-sharing transformer and a center-tapped head of said second current-sharing transformer are connected with said first set of DC loads and said second set of DC loads.

7. The current-sharing supply circuit according to claim 1 wherein each of said first output rectifier circuit and said second output rectifier circuit is a bridge rectifier circuit, a full-wave rectifier circuit or a half-wave rectifier circuit.

8. The current-sharing supply circuit according to claim 1 wherein each of said first set of DC loads and said second set of DC loads includes one light emitting diode or multiple serially-connected light emitting diodes.

9. The current-sharing supply circuit according to claim 1 wherein said current providing circuit comprises:
an isolation transformer having a secondary winding assembly connected with an input terminal of said current-sharing circuit;
a control circuit for generating at least a first pulse width modulation signal for controlling operations of said current providing circuit; and
a switching circuit having a power output terminal connected with a primary winding assembly of said isolation transformer and a control terminal connected with said control circuit, wherein electrical energy of said input voltage is selectively transmitted to said primary winding assembly of said isolation transformer through said switching circuit according to said first pulse width modulation signal.

10. The current-sharing supply circuit according to claim 9 wherein said switching circuit comprises:
a first switch element having a first end connected with said primary winding assembly of said isolation transformer, and a control terminal connected with said control circuit, wherein said first switch element is selectively conducted or shut off according to said first pulse width modulation signal; and
a second switch element having a second end connected with said primary winding assembly of said isolation transformer and a first end of said first switch element, and a control terminal connected with said control circuit, wherein said second switch element is selectively conducted or shut off according to a second pulse width modulation signal generated by said control circuit,
wherein under control of said control circuit, said first switch element and said second switch element are selectively conducted or shut off according to said first pulse width modulation signal and said second pulse width modulation signal, so that electrical energy of said input voltage is selectively transmitted to said primary winding assembly of said isolation transformer through said first switch element or said second switch element, and said primary winding assembly is subject to a voltage variation.

11. The current-sharing supply circuit according to claim 10 wherein said switching circuit further comprises:
a third switch element having a first end connected with said primary winding assembly of said isolation transformer, a second end connected with a second end of said first switch element, and a control terminal connected with said control circuit, wherein said third switch element is selectively conducted or shut off according to a third pulse width modulation signal generated by said control circuit; and
a fourth switch element having a second end connected with said first end of said third switch element and said primary winding assembly of said isolation transformer, and a control terminal connected with said control circuit, wherein said fourth switch element is selectively conducted or shut off according to a fourth pulse width modulation signal generated by said control circuit,
wherein under control of said control circuit, said first switch element, said second switch element, said third switch element and said fourth switch element are selectively conducted or shut off according to said first pulse width modulation signal, said second pulse width modulation signal, said third pulse width modulation signal and said fourth pulse width modulation signal, so that electrical energy of said input voltage is selectively transmitted to said primary winding assembly of said isolation transformer through said first switch element, said second switch element, said third switch element or said fourth switch element, and said primary winding assembly is subject to a voltage variation.

12. The current-sharing supply circuit according to claim 11 wherein said first switch element, said second switch element, said third switch element and said fourth switch element are metal oxide semiconductor field effect transistors or bipolar junction transistors.

13. The current-sharing supply circuit according to claim 9 wherein said control circuit is a digital signal processor, a micro processor, a pulse width modulation controller, or a pulse frequency modulation controller.

14. The current-sharing supply circuit according to claim 9 wherein said current providing circuit further comprises a resonant circuit interconnected between said power output terminal of said switching circuit and said primary winding assembly of said isolation transformer.

15. The current-sharing supply circuit according to claim 14 wherein said resonant circuit includes a resonant capacitor, which is serially connected between said power output terminal of said switching circuit and said primary winding assembly of said isolation transformer.

16. The current-sharing supply circuit according to claim 15 wherein said resonant circuit further includes a resonant inductor, wherein said resonant inductor and said resonant capacitor are serially connected between said power output terminal of the switching circuit and said primary winding assembly of said isolation transformer.

17. The current-sharing supply circuit according to claim 1 wherein said current-sharing supply circuit further comprises a rectifier circuit, wherein an output terminal of said rectifier circuit is connected to a power input terminal of said current providing circuit through a bus, said input voltage is rectified into bus voltage by said rectifier circuit, and said bus voltage is transmitted to said power input terminal of said current providing circuit.

18. The current-sharing supply circuit according to claim 17 wherein said current-sharing supply circuit further comprises a bus capacitor connected with said bus for filtering and storing electrical energy.

19. A current-sharing supply circuit for driving multiple sets of DC loads, wherein said current-sharing supply circuit comprises:
a current providing circuit for receiving an input voltage and generating a first current or a first voltage, thereby providing electrical energy to said first set of DC loads and said second set of DC loads;
a current-sharing circuit connected with power output terminal of said current providing circuit, and comprising multiple current-sharing transformer sets and at least a first coupling inductor member, wherein each current-sharing transformer set comprises at least one layer; and
multiple output rectifier circuits interconnected between respective set of DC loads and said output terminal of said current-sharing circuit for rectification, thereby generating respective output currents to respective set of DC loads,
wherein said output currents are balanced by said current-sharing circuit.

20. The current-sharing supply circuit according to claim 19 wherein said current-sharing circuit further comprises a second coupling inductor member.

21. The current-sharing supply circuit according to claim 20 wherein said current-sharing circuit further comprises a third coupling inductor member.

22. The current-sharing supply circuit according to claim 21 wherein said first coupling inductor member comprises a first inductor and a second inductor, said second coupling inductor member comprises a third inductor and a fourth inductor, and said third coupling inductor member comprises a fifth inductor and a sixth inductor.

23. The current-sharing supply circuit according to claim 22 wherein said multiple current-sharing transformer sets comprise a first current-sharing transformer set, a second current-sharing transformer set and a third current-sharing transformer set, a first layer of each of said first, second and third current-sharing transformer sets comprises a first current-sharing transformer and a second current-sharing transformer,
wherein a primary winding assembly of said first current-sharing transformer of said first current-sharing transformer set, a primary winding assembly of said second current-sharing transformer of said first current-sharing transformer set and said first inductor of said first coupling inductor member are serially connected with said power output terminal of said current providing circuit, a secondary winding assembly of said first current-sharing transformer of said first current-sharing transformer set is connected with a first one of said output rectifier circuits, and a secondary winding assembly of said second current-sharing transformer of said first current-sharing transformer set is connected with a second one of said output rectifier circuits,
wherein a primary winding assembly of said first current-sharing transformer of said second current-sharing transformer set, a primary winding assembly of said second current-sharing transformer of said second current-sharing transformer set and said first inductor of said first coupling inductor member are serially connected with said power output terminal of said current providing circuit, a secondary winding assembly of said first current-sharing transformer of said second current-sharing transformer set is connected with a third one of said output rectifier circuits, and a secondary winding assembly of said second current-sharing transformer of said second current-sharing transformer set is connected with a fourth one of said output rectifier circuits,
wherein a primary winding assembly of said first current-sharing transformer of said third current-sharing transformer set, a primary winding assembly of said second current-sharing transformer of said third current-sharing transformer set and said first inductor of said first coupling inductor member are serially connected with said power output terminal of said current providing circuit, a secondary winding assembly of said first current-sharing transformer of said third current-sharing transformer set is connected with a fifth one of said output rectifier circuits, and a secondary winding assembly of said second current-sharing transformer of said third current-sharing transformer set is connected with a sixth one of said output rectifier circuits, and
wherein said second inductor, said fourth inductor and said sixth inductor are connected with each other.

24. The current-sharing supply circuit according to claim 19 wherein each of said output rectifier circuits is a bridge rectifier circuit, a full-wave rectifier circuit or a half-wave rectifier circuit.

25. The current-sharing supply circuit according to claim 19 wherein each of said first set of DC loads and said second set of DC loads includes one light emitting diode or multiple serially-connected light emitting diodes.

26. The current-sharing supply circuit according to claim 19 wherein said current providing circuit comprises:
an isolation transformer having a secondary winding assembly connected with an input terminal of said current-sharing circuit;
a control circuit for generating at least a first pulse width modulation signal for controlling operations of said current providing circuit; and
a switching circuit having a power output terminal connected with a primary winding assembly of said isolation transformer and a control terminal connected with said control circuit, wherein electrical energy of said input voltage is selectively transmitted to said primary winding assembly of said isolation transformer through said switching circuit according to said first pulse width modulation signal.

27. The current-sharing supply circuit according to claim 26 wherein said switching circuit comprises:
a first switch element having a first end connected with said primary winding assembly of said isolation transformer, and a control terminal connected with said control circuit, wherein said first switch element is selectively conducted or shut off according to said first pulse width modulation signal; and
a second switch element having a second end connected with said primary winding assembly of said isolation transformer and a first end of said first switch element, and a control terminal connected with said control circuit, wherein said second switch element is selectively conducted or shut off according to a second pulse width modulation signal generated by said control circuit,
wherein under control of said control circuit, said first switch element and said second switch element are selectively conducted or shut off according to said first pulse width modulation signal and said second pulse width modulation signal, so that electrical energy of said input voltage is selectively transmitted to said primary winding assembly of said isolation transformer through said first switch element or said second switch element, and said primary winding assembly is subject to a voltage variation.

28. The current-sharing supply circuit according to claim 27 wherein said switching circuit further comprises:
a third switch element having a first end connected with said primary winding assembly of said isolation transformer, a second end connected with a second end of said first switch element, and a control terminal connected with said control circuit, wherein said third switch element is selectively conducted or shut off according to a third pulse width modulation signal generated by said control circuit; and
a fourth switch element having a second end connected with said first end of said third switch element and said primary winding assembly of said isolation transformer, and a control terminal connected with said control circuit, wherein said fourth switch element is selectively conducted or shut off according to a fourth pulse width modulation signal generated by said control circuit,
wherein under control of said control circuit, said first switch element, said second switch element, said third switch element and said fourth switch element are selectively conducted or shut off according to said first pulse width modulation signal, said second pulse width modulation signal, said third pulse width modulation signal and said fourth pulse width modulation signal, so that electrical energy of said input voltage is selectively transmitted to said primary winding assembly of said isolation transformer through said first switch element, said second switch element, said third switch element or said fourth switch element, and said primary winding assembly is subject to a voltage variation.

29. The current-sharing supply circuit according to claim 26 wherein said current providing circuit further comprises a resonant circuit interconnected between said power output terminal of said switching circuit and said primary winding assembly of said isolation transformer.

30. The current-sharing supply circuit according to claim 29 wherein said resonant circuit includes a resonant capacitor, which is serially connected between said power output terminal of said switching circuit and said primary winding assembly of said isolation transformer.

31. The current-sharing supply circuit according to claim 30 wherein said resonant circuit further includes a resonant inductor, wherein said resonant inductor and said resonant capacitor are serially connected between said power output terminal of the switching circuit and said primary winding assembly of said isolation transformer.

32. The current-sharing supply circuit according to claim 19 wherein said current-sharing supply circuit further comprises a rectifier circuit, wherein an output terminal of said rectifier circuit is connected to a power input terminal of said current providing circuit through a bus, said input voltage is rectified into bus voltage by said rectifier circuit, and said bus voltage is transmitted to said power input terminal of said current providing circuit.

33. The current-sharing supply circuit according to claim 32 wherein said current-sharing supply circuit further comprises a bus capacitor connected with said bus for filtering and storing electrical energy.

34. A current-sharing supply circuit for driving multiple sets of DC loads, said current-sharing supply circuit comprising:
a current providing circuit for receiving an input voltage and generating a first current or a first voltage, thereby providing electrical energy to said first set of DC loads and said second set of DC loads;
a current-sharing circuit connected with power output terminal of said current providing circuit, and comprising a first current-sharing transformer set, wherein said current-sharing transformer set comprises at least one layer; and
multiple output rectifier circuits interconnected between respective set of DC loads and said output terminal of said current-sharing circuit for rectification, thereby generating respective output currents to respective set of DC loads,
wherein said output currents are balanced by said current-sharing circuit.

35. The current-sharing supply circuit according to claim 34 wherein a first layer of said first current-sharing transformer set comprises multiple current-sharing transformers, a second layer of said first current-sharing transformer set comprises multiple current-sharing branches, each of said current-sharing branches comprises multiple current-sharing transformers, primary winding assemblies of said current-sharing transformers of each current-sharing branch are serially connected with secondary winding assemblies of corresponding current-sharing transformers of the former layer, and secondary winding assemblies of current-sharing transformers of the last layer are connected with corresponding output rectifier circuits.

36. The current-sharing supply circuit according to claim 35 wherein said primary winding assemblies of said current-sharing transformers of said first layer are serially connected with said power output terminal of said current providing circuit.

37. The current-sharing supply circuit according to claim 34 wherein said current-sharing circuit further comprises a coupling inductor member and a second current-sharing transformer sets, a first layer of said first current-sharing transformer set comprises multiple current-sharing transformers, a first layer of said second current-sharing transformer set comprises multiple current-sharing transformers, primary winding assemblies of said current-sharing transformers of said first layer of said first current-sharing transformer set and an inductor of coupling inductor member are serially connected with said power output terminal of said current providing circuit, and primary winding assemblies of said current-sharing transformers of said first layer of said second current-sharing transformer set and another inductor of coupling inductor member are serially connected with said power output terminal of said current providing circuit.

38. The current-sharing supply circuit according to claim 37 wherein a second layer of said first current-sharing transformer set comprises multiple current-sharing branches, and a second layer of said second current-sharing transformer set comprises multiple current-sharing branches.

39. The current-sharing supply circuit according to claim 34 wherein each of said output rectifier circuits is a bridge rectifier circuit, a full-wave rectifier circuit or a half-wave rectifier circuit.

40. The current-sharing supply circuit according to claim 34 wherein each of aid first set of DC loads and said second set of DC loads includes one light emitting diode or multiple serially-connected light emitting diodes.

41. The current-sharing supply circuit according to claim 34 wherein said current providing circuit comprises:
an isolation transformer having a secondary winding assembly connected with an input terminal of said current-sharing circuit;
a control circuit for generating at least a first pulse width modulation signal for controlling operations of said current providing circuit; and
a switching circuit having a power output terminal connected with a primary winding assembly of said isolation transformer and a control terminal connected with said control circuit, wherein electrical energy of said input voltage is selectively transmitted to said primary winding assembly of said isolation transformer through said switching circuit according to said first pulse width modulation signal.

42. The current-sharing supply circuit according to claim 41 wherein said switching circuit comprises:
a first switch element having a first end connected with said primary winding assembly of said isolation transformer, and a control terminal connected with said control circuit, wherein said first switch element is selectively conducted or shut off according to said first pulse width modulation signal; and
a second switch element having a second end connected with said primary winding assembly of said isolation transformer and a first end of said first switch element, and a control terminal connected with said control circuit, wherein said second switch element is selectively conducted or shut off according to a second pulse width modulation signal generated by said control circuit,
wherein under control of said control circuit, said first switch element and said second switch element are selectively conducted or shut off according to said first pulse width modulation signal and said second pulse width modulation signal, so that electrical energy of said input voltage is selectively transmitted to said primary winding assembly of said isolation transformer through said first switch element or said second switch element, and said primary winding assembly is subject to a voltage variation.

43. The current-sharing supply circuit according to claim 42 wherein said switching circuit further comprises:
a third switch element having a first end connected with said primary winding assembly of said isolation transformer, a second end connected with a second end of said first switch element, and a control terminal connected with said control circuit, wherein said third switch element is selectively conducted or shut off according to a third pulse width modulation signal generated by said control circuit; and
a fourth switch element having a second end connected with said first end of said third switch element and said primary winding assembly of said isolation transformer, and a control terminal connected with said control circuit, wherein said fourth switch element is selectively conducted or shut off according to a fourth pulse width modulation signal generated by said control circuit,
wherein under control of said control circuit, said first switch element, said second switch element, said third switch element and said fourth switch element are selectively conducted or shut off according to said first pulse width modulation signal, said second pulse width modulation signal, said third pulse width modulation signal and said fourth pulse width modulation signal, so that electrical energy of said input voltage is selectively transmitted to said primary winding assembly of said isolation transformer through said first switch element, said second switch element, said third switch element or said fourth switch element, and said primary winding assembly is subject to a voltage variation.

44. The current-sharing supply circuit according to claim 41 wherein said current providing circuit further comprises a resonant circuit interconnected between said power output terminal of said switching circuit and said primary winding assembly of said isolation transformer.

45. The current-sharing supply circuit according to claim 44 wherein said resonant circuit includes a resonant capacitor, which is serially connected between said power output terminal of said switching circuit and said primary winding assembly of said isolation transformer.

46. The current-sharing supply circuit according to claim 45 wherein said resonant circuit further includes a resonant inductor, wherein said resonant inductor and said resonant capacitor are serially connected between said power output terminal of the switching circuit and said primary winding assembly of said isolation transformer.

47. The current-sharing supply circuit according to claim 34 wherein said current-sharing supply circuit further comprises a rectifier circuit, wherein an output terminal of said rectifier circuit is connected to a power input terminal of said current providing circuit through a bus, said input voltage is rectified into bus voltage by said rectifier circuit, and said bus voltage is transmitted to said power input terminal of said current providing circuit.

48. The current-sharing supply circuit according to claim 47 wherein said current-sharing supply circuit further comprises a bus capacitor connected with said bus for filtering and storing electrical energy.
